(19) United States
(12) Patent Application Publication
(10) Pub. No.: US 2012/0043820 A1
(43) Pub. Date: Feb. 23, 2012

(54) FUEL CELL SYSTEM HAVING BYPASS CIRCUIT AND METHOD OF DRIVING THE SAME

(76) Inventors: Tae-Ho Kwon, Yongin-si (KR); Sang-Jun Kong, Yongin-si (KR); Hyun-Min Son, Yongin-si (KR)

(21) Appl. No.: 13/204,479

(22) Filed: Aug. 5, 2011

(30) Foreign Application Priority Data
Aug. 19, 2010 (KR) 10-2010-0080291

(51) Int. Cl. H02J 1/00

(52) U.S. Cl. 307/80

(57) ABSTRACT

Disclosed is a fuel cell system, which bypasses a cell, bundle, or stack. The fuel cell system includes a stack, which includes at least one unit cell including an anode, a cathode, and an electrolyte formed between the anode and the cathode. The unit cell produces electricity via an electrochemical reaction of hydrogen and oxygen provided from the anode and the cathode. The fuel cell system includes switches connected in series for connecting the unit cells in series or for short-circuiting one unit cell with adjacent unit cells, and a bypass switch to connect two unit cells separated by at least one unit cell. The fuel cell system reduces or minimizes influence of a defective cell, bundle, or stack on another normal cell, bundle, or stack, and thus the fuel cell system may operate for a long time and have excellent durability.

### CROSS-REFERENCE TO RELATED APPLICATION

This application claims priority to and the benefit of Korean Patent Application No. 10-2010-0080291, filed on Aug. 19, 2010, in the Korean Intellectual Property Office, the entire content of which is incorporated herein by reference.

### BACKGROUND

1. Field

Aspects of embodiments according to the present invention relate to a fuel cell system and a method of driving the same.

2. Description of Related Art

A fuel cell is a system that converts fuel into electric energy. The fuel cell may include a pair of electrodes (namely, an anode and a cathode) separated by an electrolyte interposed therebetween. The fuel cell produces electricity and heat through an electrochemical reaction of a fuel (for example, fuel gas such as hydrogen) and an oxidant (for example, an oxidation gas such as oxygen), which are ionized when the anode (oxidation electrode or fuel electrode) comes in contact with, for example, hydrogen or fuel gas containing hydrogen, and the cathode (reduction electrode or air electrode) comes in contact with, for example, oxidation gas containing oxygen.

A stack of the fuel cell may exhibit its designed capacity when unit cells connected in series have the same properties of voltage and current. However, when one of the unit cells connected in series becomes defective, it can change the current and voltage properties of the stack. Accordingly, the entire stack may deteriorate in capacity. As a result, when one unit cell becomes defective, the entire stack may need replacing.

In bundles of unit cells connected in parallel, when defective bundles are ignored, an output voltage variation between bundles may take place, which can result in an abnormal voltage being output instead of a designed output voltage. Further, voltage differences and internal resistance differences between bundles may cause electric current to flow in reverse in the fuel cell. Accordingly, the entire fuel cell may deteriorate in efficiency and have serious trouble.

### SUMMARY

Exemplary embodiments of the present invention provide for a fuel cell system that enables bypassing to effectively isolate a defective cell, bundle, or stack from other normal cells, bundles, or stacks so that the defective cell, bundle, or stack does not influence the other normal cells, bundles, or stacks, and a method for driving the same.

Further, exemplary embodiments provide for a fuel cell system that effectively isolates a defective cell, bundle, or stack from other normal cells, bundles, or stacks to easily replace cells, bundles, or stacks deteriorated in capacity, and a method for driving the same.

In addition, exemplary embodiments provide for a fuel cell system that reduces or minimizes influence of a defective cell, bundle, or stack on another normal cell, bundle, or stack among bundles connected in series or in parallel. Thus, the fuel cell system may operate for a long time and have excellent durability. Also provided is a method of driving such a fuel cell system.

According to an exemplary embodiment of the present invention, a fuel cell system is provided. The fuel cell system includes a plurality of bundles, a detecting unit, a bypass circuit, a switching circuit, and a controller. Each of the plurality of bundles is connected to one or more adjacent others of the plurality of bundles, and includes one or more unit cells configured to generate electricity. The detecting unit is for detecting a defective bundle from among the plurality of bundles. The bypass circuit is for bypassing the defective bundle. The switching circuit is between adjacent ones of the plurality of bundles and for connecting and disconnecting the adjacent ones of the plurality of bundles to each other and to the bypass circuit. The controller is for controlling the switching circuit to bypass the defective bundle.

The detecting unit may include a voltage detector. The voltage detector is for detecting an output voltage of the defective bundle. The controller may be configured to determine if the bundle is defective in accordance with the detected output voltage of the defective bundle and a detected output voltage of another of the plurality of bundles.

The detecting unit may include a voltage detector. The voltage detector is for detecting an output voltage of the defective bundle. The controller may be configured to determine if the defective bundle is defective in accordance with the detected output voltage of the defective bundle and a reference voltage.

The detecting unit may include a temperature sensor. The temperature sensor is for measuring a temperature of the defective bundle. The controller may be configured to determine if the defective bundle is defective in accordance with the measured temperature of the defective bundle and a measured temperature of another of the plurality of bundles.

The detecting unit may include a temperature sensor. The temperature sensor is for measuring a temperature of the defective bundle. The controller may be configured to determine if the defective bundle is defective in accordance with the measured temperature of the defective bundle and a reference temperature.

The switching circuit may include a 3-position switch. The 3-position switch is for selectively connecting the adjacent ones of the plurality of bundles, or one of the adjacent ones of the plurality of bundles and the bypass circuit.

The switching circuit may include a solenoid switch, a trip coil, or an insulated gate bipolar transistor (IGBT).

The switching circuit may include a plurality of local area network (LAN) switches to which respective Internet Protocol (IP) addresses are allocated. The controller may be configured to control the LAN switches to bypass the defective bundle.

The fuel cell system may further include a housing. The housing contains the plurality of bundles. The controller may include an external circuit of a printed circuit board (PCB) or a distributing board on an outside of the housing.

The fuel cell system may further include a cooling unit between the external circuit and the housing.

According to another exemplary embodiment of the present invention, a method of driving a fuel cell system is provided. The method includes: driving a fuel cell comprising a plurality of unit cells; detecting a defective cell of the unit cells while the fuel cell is being driven; and bypassing the detected cell using a bypass circuit and a switching circuit.

The detecting the defective cell may include using a measured temperature of the defective cell.

The detecting the defective cell may include: measuring a temperature of each of the unit cells; comparing the measured temperature of the defective cell with the corresponding measured temperature of each of others of the unit cells; and determining the defective cell is defective when the measured temperature of the defective cell varies in accordance with a reference value or more from an average temperature of the corresponding measured temperature of each of the others of the unit cells.

The detecting the defective cell may include: measuring a temperature of the defective cell; comparing the measured temperature of the defective cell with a reference temperature; and determining the defective cell is defective when the measured temperature of the defective cell is out of a range set in accordance with the reference temperature.

The detecting the defective cell may include using a measured output voltage of the defective cell.

The detecting the defective cell may include: measuring an output voltage of each of the unit cells; comparing the measured output voltage of the defective cell with the corresponding measured output voltage of each of others of the unit cells; and determining the defective cell is defective when the measured output voltage of the defective cell varies in accordance with a reference value or more from an average output voltage of the corresponding measured output voltage of each of the others of the unit cells.

The detecting the defective cell may include: measuring an output voltage of the defective unit cell; comparing the measured output voltage of the defective cell with a reference output voltage; and determining the defective cell is defective when the measured output voltage of the defective cell is out of a range set in accordance with the reference output voltage.

### BRIEF DESCRIPTION OF THE DRAWINGS

The accompanying drawings, together with the specification, illustrate exemplary embodiments of the present invention, and, together with the description, serve to explain aspects and principles of the present invention.

FIG. 1 illustrates a configuration of an example stack used for a fuel cell;

FIG. 2 is a block diagram illustrating a fuel cell with a bypass circuit and switching circuits according to an exemplary embodiment of the present invention;

FIG. 3 illustrates a switching circuit according to an exemplary embodiment of the present invention;

FIG. 4 is a block diagram illustrating a method of bypassing a defective bundle according to an exemplary embodiment of the present invention;

FIG. 5 is a block diagram illustrating a method of bypassing a plurality of defective bundles according to an exemplary embodiment of the present invention;

FIG. 6 is a block diagram illustrating a connected detecting unit according to an exemplary embodiment of the present invention;

FIG. 7 is a schematic view illustrating a cooling unit and a controller according to an exemplary embodiment of the present invention;

FIG. 8 is a flowchart illustrating a method of driving a fuel cell system according to an exemplary embodiment of the present invention; and

FIGS. 9A and 9B are flowcharts illustrating processes of detecting a defective cell according to exemplary embodiments of the present invention.

### DETAILED DESCRIPTION

In the following detailed description, exemplary embodiments of the present invention are shown and described, simply by way of illustration. As those skilled in the art would realize, the described embodiments may be modified in various ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. In addition, when an element is referred to as being “connected to” another element, it can be directly connected to the other element or be indirectly connected to the other element with one or more intervening elements interposed therebetween. Hereinafter, like reference numerals refer to like elements throughout.

Further, it is understood that, although the terms first, second, third, etc., may be used herein to describe various elements, components, regions, layers, and/or sections, these elements, components, regions, layers, and/or sections should not be limited by these terms. These terms may be used to distinguish one element, component, region, layer, or section from another element, component, region, layer, or section. Thus, a first element, component, region, layer, or section discussed below could be termed a second element, component, region, layer, or section without departing from the spirit or scope of the present invention.

In addition, the terminology used herein is for describing particular embodiments and is not intended to be limiting of the invention. As used herein, the singular forms “a,” “an,” and “the” are intended to include the plural forms as well, unless the context clearly indicates otherwise. It is further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof.

Hereinafter, exemplary embodiments of the present invention are described in detail with reference to the accompanying drawings.

FIG. 1 illustrates a configuration of an example stack used for a fuel cell.

Referring to FIG. 1, in the fuel cell, the stack (which produces electricity) has a structure that includes several to hundreds of unit cells. Here, a unit cell includes a membrane electrode assembly (MEA) including a pair of electrodes—namely, an anode 110 and a cathode 120—separated by an electrolyte membrane 130 interposed therebetween, and a bipolar plate 140 to separate respective MEAs. The stack further includes an end plate 150 connected to an external device.

The fuel cell is a system that converts fuel into electric energy. In the fuel cell of FIG. 1, for example, the anode 110 comes in contact with hydrogen or fuel gas containing hydrogen, and the cathode 120 comes in contact with oxidation gas containing oxygen. Then, hydrogen ions that transfer to the cathode 120 through the electrolyte membrane 130 generate an electrochemical reduction reaction with oxygen provided to the cathode 120, thereby producing electric energy, heat, and water.

Here, the unit cell may have various shapes such as a circle, a rod, and the like. Further, each unit cell may have a layered structure such as that shown in FIG. 1 and be arranged in parallel into a stack.

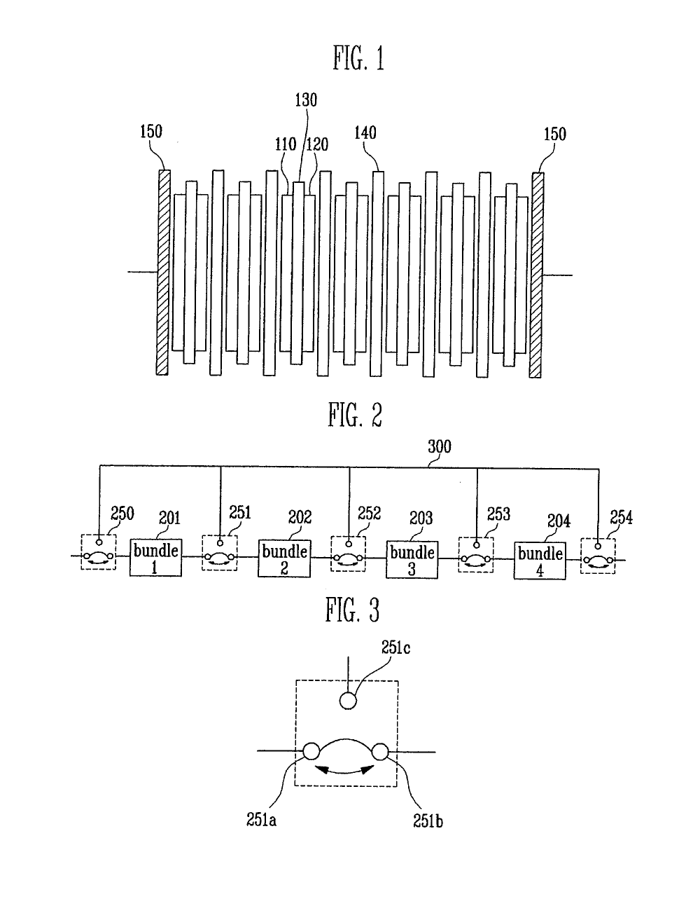

The stack may be operated in a unit cell or in a unit cell bundle including a plurality of unit cells, and one fuel cell may include a plurality of stacks. Hereinafter, although description with reference to FIGS. 2 to 4 is made with a stack including a plurality of bundles, a bypass method according to exemplary embodiments of the present invention may be applied to a unit cell or a plurality of stacks that constitute one fuel cell.

FIG. 2 illustrates a configuration of a fuel cell including a bypass circuit 300 and switching circuits 250, 251, 252, 253, and 254 according to an exemplary embodiment of the present invention. FIG. 3 illustrates a switching circuit according to an exemplary embodiment of the present invention.

Referring to FIG. 2, the fuel cell includes a stack formed of four unit cell bundles 201, 202, 203, and 204, the bypass circuit 300, and the switching circuits 250, 251, 252, 253, and 254 to bypass a bundle (for example, a predetermined bundle). The bypass circuit 300 has terminals connected to nodes between the respective bundles 201, 202, 203, and 204. The respective terminals are electrically connected to electrically bypass the respective bundles 201, 202, 203, and 204.

Referring to FIGS. 2 and 3, the switching circuits 250, 251, 252, 253, and 254 are described. The switching circuits 250, 251, 252, 253, and 254 are provided between and on either side of the respective bundles 201, 202, 203, and 204. The switching circuits 250, 251, 252, 253, and 254 switch on and off electrical connection of the respective bundles 201, 202, 203, and 204 and switch on and off electrical connection of the respective bundles 201, 202, 203, and 204 with a terminal 251c of the bypass circuit 300. Each of the switching circuits 250, 251, 252, 253, and 254 may be configured as a 3-position switch, as shown in FIG. 3. That is, the terminal 251c of the bypass circuit 300 and terminals 251a and 251b connected to adjacent bundles are selectively (for example, pairwise) connected and disconnected.

Here, a switching circuit 250 connects the terminal 251c of the bypass circuit 300 to the terminal 251a of an adjacent bundle, connects the terminal 251c of the bypass circuit 300 to the terminal 251b of another adjacent bundle, or connects the terminals 251a and 251b of the two adjacent bundles. In the present embodiment, the switching circuits 250, 251, 252, 253, and 254 have been illustrated with a configuration having a minimum function, but the switching circuits 250, 251, 252, 253, and 254 may be configured as various types of switching circuits including the function of the present embodiment.

FIG. 2 shows a state before a defective unit cell bundle is detected, the switching circuits 250, 251, 252, 253, and 254 connecting the adjacent bundles 201, 202, 203, and 204.

Here, the switching circuits 250, 251, 252, 253, and 254 may be configured as various types of switches, such as solenoid switch, trip coil, insulated gate bipolar transistor (IGBT), or the like. Further, the switching circuits 250, 251, 252, 253, and 254 may be configured as a plurality of local area network (LAN) switches to which respective Internet Protocol (IP) addresses (for example, respective unique IP addresses) are allocated. Here, a unique identification number is allocated to each of the switching circuits 250, 251, 252, 253, and 254, so that each switch is easily controlled via a computer network and is rapidly controlled as compared with a mechanical switch.

The fuel cell further includes a controller (for example, see FIG. 7) to detect a defective unit cell bundle (hereinafter, referred to as ‘defective bundle’) causing a capacity variation among the unit cell bundles 201, 202, 203, and 204, and to control the switching circuits 250, 251, 252, 253, and 254 to bypass a detected defective bundle.

FIG. 4 illustrates a method of bypassing a defective bundle according to an exemplary embodiment of the present invention.

Referring to FIG. 4, a second bundle 202 is detected to be defective among the four unit cell bundles 201, 202, 203, and 204 shown in FIG. 2. The controller controls the defective second bundle 202 and adjacent two switching circuits 251 and 252. Here, the switching circuit 251 between a first bundle 201 and the second bundle 202 is switched so that the first bundle 201 is not connected to the second bundle 202, and the first bundle 201 is connected to the bypass circuit 300. The switching circuit 252 between the second bundle 202 and a third bundle 203 is switched so that the second bundle 202 is not connected to the third bundle 203, and the third bundle 203 is connected to the bypass circuit 300.

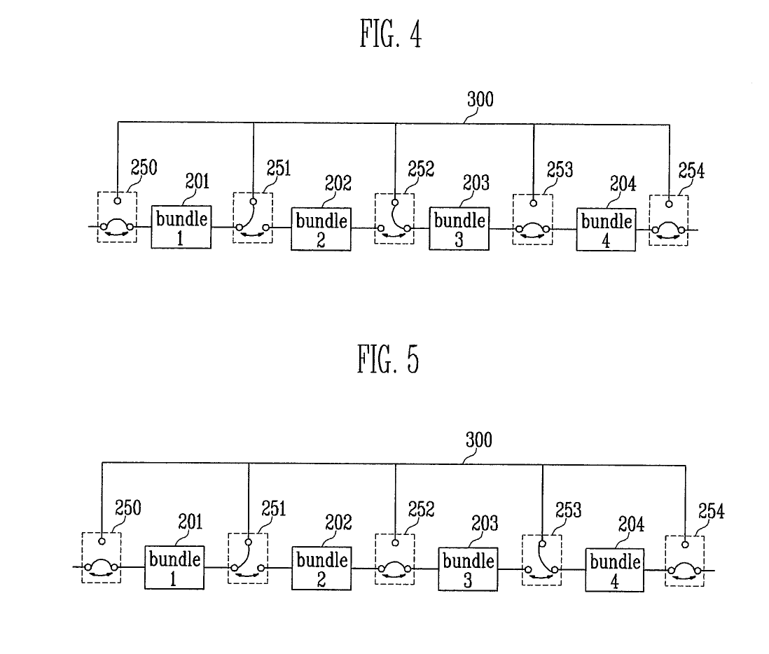

FIG. 5 is a block diagram illustrating a method of bypassing a plurality of defective bundles according to an exemplary embodiment of the present invention. Referring to FIG. 5, the second bundle 202 and the third bundle 203 are detected to be defective among the four unit cell bundles 201, 202, 203, and 204.

The controller controls the defective second bundle 202, the defective third bundle 203, and the two switching circuits 251 and 253. The switching circuit 251 provided between the first bundle 201 and the second bundle 202 is switched so that the first bundle 201 is not connected to the second bundle 202, and the first bundle 201 is connected to the bypass circuit 300. The switching circuit 253 provided between the third bundle 203 and a fourth bundle 204 is switched so that the third bundle 203 is not connected to the fourth bundle 204, and the fourth bundle 204 is connected to the bypass circuit 300.

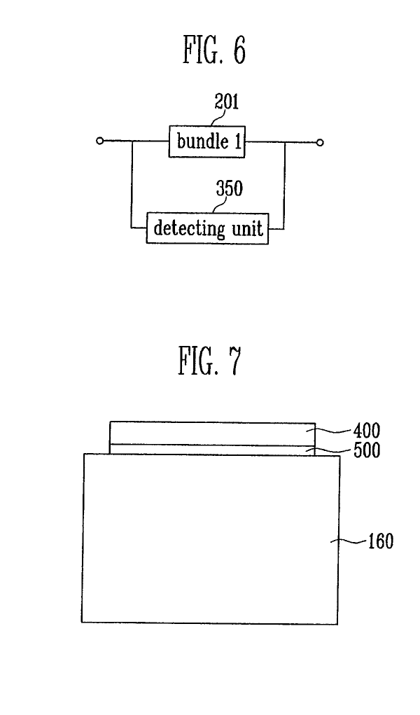

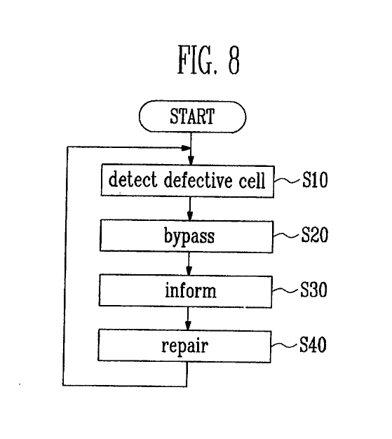

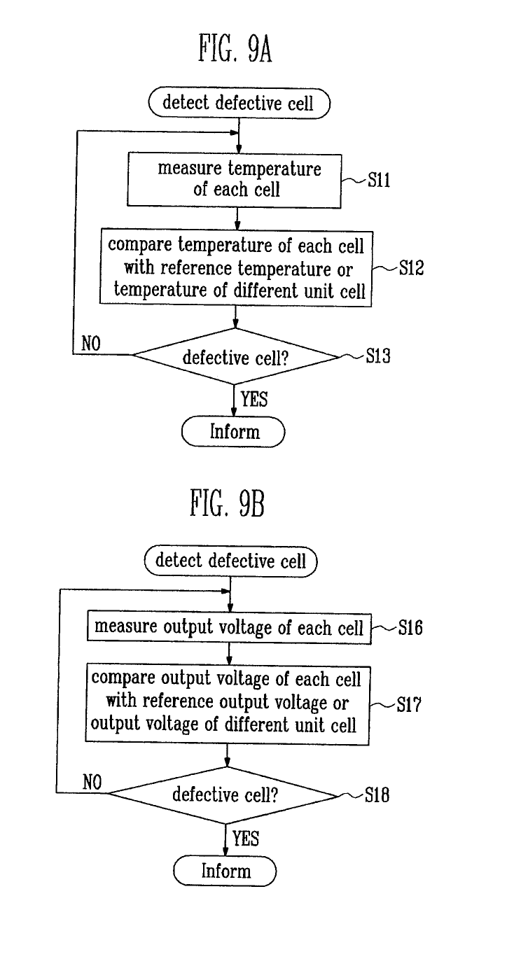

FIG. 6 is a block diagram illustrating a connected detecting unit 350 according to an exemplary embodiment of the present invention, and FIG. 7 is a schematic view illustrating a cooling unit 500 and a controller 400 according to an exemplary embodiment of the present invention. Further, FIG. 8 is a flowchart illustrating a method of driving a fuel cell system according to an exemplary embodiment of the present invention, and FIGS. 9A and 9B are flowcharts illustrating processes of detecting a defective cell according to exemplary embodiments of the present invention.

The controller 400 shown in FIG. 7 may be provided as an external circuit of, for example, a printed circuit board (PCB) or a distributing board on an outside of a housing 160 containing the bundles 201, 202, 203, and 204 and the detecting unit 350 inside. Here, the cooling unit 500 may further be disposed between the controller 400 and the housing 160, as shown in FIG. 7. The cooling unit 500 functions to prevent the controller 400 from being excessively heated so as not to cause a malfunction.

The detecting unit 350 is provided in each of the bundles 201, 202, 203, and 204 to detect a defective bundle. The detecting unit 350 is provided as shown in FIG. 6 to, for example, detect an output voltage from the respective bundles 201, 202, 203, and 204 or to measure temperature through a temperature sensor provided in the bundles 201, 202, 203, and 204. The controller (for example, see FIG. 7) determines that a cell which outputs abnormal power or has an abnormal temperature, as measured by the detecting unit 350, is a defective cell.

In other embodiments, the detecting unit 350 may be provided for multiple bundles. For example, in other embodiments, there may be one detecting unit 350 to detect output voltages from, or measure temperatures of, bundles 201, 202, 203, and 204.

A process of detecting a defective bundle is described with reference to FIGS. 8 to 9B.

The method of driving the fuel cell system is described with reference to FIG. 8. First, a defective cell that is deteriorated in capacity is detected (S10). Then, the controller (for example, see FIG. 7) controls the switching circuits 250, 251, 252, 253, and 254 to bypass the defective cell through the bypass circuit 300 (for example, see FIGS. 2 and 4-5) (S20). The controller informs an administrator of the detected defective cell (S30). The administrator takes measures to repair the defective cell (S40).

Here, the process of detecting the defective cell may be implemented in three steps as follows, with reference to FIG. 9A. First, the temperature of each unit cell is measured (S11). Then, the measured temperature of each unit cell is compared with a reference temperature (for example, a preset reference temperature) or a measured temperature of a different unit cell (S12). The measured temperature of the different unit cell may be obtained, for example, by calculating an average value of the measured temperatures of two or more unit cells. Finally, the controller determines a cell to be defective, the cell having a measured temperature that is out of a range of the preset reference temperature or having a temperature varying by an amount equal to or greater than a reference value from the average temperature obtained from the different unit cells (S13).

Here, data associated with the reference temperature and the reference value from the different unit cells may be stored in advance in the controller by the administrator. Further, the range of the preset reference temperature refers to a range in which various types of fuel cells are determined to operate normally. For example, polymer electrolyte membrane fuel cells (PEMFCs) having a driving temperature of about 85° C. to about 100° C. are determined to operate normally when a measured temperature of each cell is in the above range. In the same manner, solid oxide fuel cells (SOFCs) are generally driven in a range of about 500° C. to about 1200° C., and direct methanol fuel cells (DMFCs) are driven in a range of about 25° C. to about 130° C. However, since each fuel cell system may have a different driving temperature depending on a designing method and materials, the temperature to normally drive a cell may be determined by the administrator.

Here, when the average value of other unit cells is used as the basis for a reference value, a cell having a temperature that varies by, for example, 5 to 10% or more from the average value may be determined to be abnormal. However, each cell may also have a different driving temperature depending on deterioration of a unit cell or a heat source providing heat and thus, a reference value may be changed by the administrator.

In another exemplary embodiment illustrated in FIG. 9B, the process of detecting the defective cell may also be implemented in three steps as follows. First, an output voltage of each unit cell is measured (S16). Then, the measured output voltage of each unit cell is compared with a reference output voltage (for example, a preset reference output voltage) or a measured output voltage of a different unit cell (S17). The measured output voltage of the different unit cell may be obtained, for example, by calculating an average value of the measured output voltages of two or more unit cells. Finally, the controller determines a cell to be defective, the cell having a measured output voltage that is out of a range of the preset reference output voltage or having an output voltage varying by an amount equal to or greater than a reference value from the average output voltage obtained from the different unit cells (S18).

Here, the preset reference output voltage and the reference value from the different unit may be determined (for example, they may be predetermined) by the administrator. Here, the preset reference output voltage refers to an open circuit voltage (OCV) that is normally output by various types of fuel cells. However, the OCV may be changed depending on types of fuel cells and thus, may not be applied collectively, but the OCV may be set by the administrator based on a design. Further, the OCV may gradually decrease over time, owing to deterioration as a driving time of a fuel cell increases. That is, the preset reference output voltage may be set to gradually decrease with a lapse of time in consideration of a deterioration degree according to a driving time.

When a defective unit cell is detected by comparing an output voltage with a voltage of other unit cells, a unit cell having an output voltage that varies by, for example, 5 to 10% or more from the average value of different unit cells may be determined to be defective. However, the reference value may be different depending on factors such as the deterioration of each unit cell, design variations, and the like. Thus, the reference value may be changed by the administrator in addition to the reference output voltage.

The above method of excluding a defective bundle using the switching circuits and the bypass circuit may be applied not only to bundles connected in series but also to bundles connected in parallel. As described above, in bundles connected in parallel, when defective bundles are ignored, an output voltage between bundles may vary, which may result in an abnormal voltage being output and thus, stability of an entire fuel cell may deteriorate. Here, cells having the same polarity in a bundle are connected, thereby simply realizing bundles connected in parallel.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fuel cell system comprising:
a plurality of bundles, each of the plurality of bundles being connected to one or more adjacent others of the plurality of bundles, and comprised of one or more unit cells configured to generate electricity;
a detecting unit for detecting a defective bundle from among the plurality of bundles;
a bypass circuit for bypassing the defective bundle;
a switching circuit between adjacent ones of the plurality of bundles and for connecting and disconnecting the adjacent ones of the plurality of bundles to each other and to the bypass circuit; and
a controller for controlling the switching circuit to bypass the defective bundle.

2. The fuel cell system of claim 1, wherein
the detecting unit comprises a voltage detector for detecting an output voltage of the defective bundle, and
the controller is configured to determine if the defective bundle is defective in accordance with the detected output voltage of the defective bundle and a detected output voltage of another of the plurality of bundles.

3. The fuel cell system of claim 1, wherein
the detecting unit comprises a voltage detector for detecting an output voltage of the defective bundle, and
the controller is configured to determine if the defective bundle is defective in accordance with the detected output voltage of the defective bundle and a reference voltage.

4. The fuel cell system of claim 1, wherein
the detecting unit comprises a temperature sensor for measuring a temperature of the defective bundle, and
the controller is configured to determine if the defective bundle is defective in accordance with the measured temperature of the defective bundle and a measured temperature of another of the plurality of bundles.

5. The fuel cell system of claim 1, wherein
the detecting unit comprises a temperature sensor for measuring a temperature of the defective bundle, and
the controller is configured to determine if the defective bundle is defective in accordance with the measured temperature of the defective bundle and a reference temperature.

6. The fuel cell system of claim 1, wherein the switching circuit comprises a 3-position switch for selectively connecting the adjacent ones of the plurality of bundles, or one of the adjacent ones of the plurality of bundles and the bypass circuit.

7. The fuel cell system of claim 1, wherein the switching circuit comprises a solenoid switch, a trip coil, or an insulated gate bipolar transistor (IGBT).

8. The fuel cell system of claim 1, wherein
the switching circuit comprises a plurality of local area network (LAN) switches to which respective Internet Protocol (IP) addresses are allocated, and
the controller is configured to control the LAN switches to bypass the defective bundle.

9. The fuel cell system of claim 1, further comprising a housing containing the plurality of bundles, wherein the controller comprises an external circuit of a printed circuit board (PCB) or a distributing board on an outside of the housing.

10. The fuel cell system of claim 9, further comprising a cooling unit between the external circuit and the housing.

11. A method of driving a fuel cell system, the method comprising:
driving a fuel cell comprising a plurality of unit cells;
detecting a defective cell of the unit cells while the fuel cell is being driven; and
bypassing the detected cell using a bypass circuit and a switching circuit.

12. The method of claim 11, wherein the detecting the defective cell comprises using a measured temperature of the defective cell.

13. The method of claim 12, wherein the detecting the defective cell comprises:
measuring a temperature of each of the unit cells;
comparing the measured temperature of the defective cell with the corresponding measured temperature of each of others of the unit cells; and
determining the defective cell is defective when the measured temperature of the defective cell varies in accordance with a reference value or more from an average temperature of the corresponding measured temperature of each of the others of the unit cells.

14. The method of claim 12, wherein the detecting the defective cell comprises:
measuring a temperature of the defective cell;
comparing the measured temperature of the defective cell with a reference temperature; and
determining the defective cell is defective when the measured temperature of the defective cell is out of a range set in accordance with the reference temperature.

15. The method of claim 11, wherein the detecting the defective cell comprises using a measured output voltage of the defective cell.

16. The method of claim 15, wherein the detecting the defective cell comprises:
measuring an output voltage of each of the unit cells;
comparing the measured output voltage of the defective cell with the corresponding measured output voltage of each of others of the unit cells; and
determining the defective cell is defective when the measured output voltage of the defective cell varies in accordance with a reference value or more from an average output voltage of the corresponding measured output voltage of each of the others of the unit cells.

17. The method of claim 15, wherein the detecting the defective cell comprises:
measuring an output voltage of the defective unit cell;
comparing the measured output voltage of the defective cell with a reference output voltage; and
determining the defective cell is defective when the measured output voltage of the defective cell is out of a range set in accordance with the reference output voltage.
